(19) United States
(12) Patent Application Publication
(10) Pub. No.: US 2009/0276722 A1
(43) Pub. Date: Nov. 5, 2009

(54) METHOD AND APPARATUS FOR DUAL MODE CONTENT SEARCHING, SELECTION, DELIVERY, AND PLAYOUT

(76) Inventor: Jonathan Segel, Ottawa (CA)

Correspondence Address: WALL & TONG, LLP/;ALCATEL-LUCENT USA INC., 595 SHREWSBURY AVENUE, SHREWSBURY, NJ, 07702, US

(21) Appl. No.: 12/112,358

(22) Filed: Apr. 30, 2008

(51) Int. Cl. G06F 3/048

(52) U.S. Cl. 715/765

(57) ABSTRACT

The invention includes a method and apparatus for searching, selecting, delivering, and presenting content to a user. In one embodiment, a method receiving content selection criteria, determining a set of candidate content items by selecting ones of a plurality of available content items using the content selection criteria, and propagating ones of the candidate content items of the set of candidate content items for presentation to the user. The entry of the content selection criteria is adapted for being controlled from a rich user interface. The presentation of the propagated ones of the candidate content items is adapted for being controlled from a_simple user interface. The rich user interface and simple user interface may be part of one user device or separate user devices. The content selection criteria may include one or more rule sets, which may be defined and executed in many ways.

### FIELD OF THE INVENTION

The invention relates to the field of communication networks and, more specifically, to controlling searching, selection, delivery, and presentation of content.

### BACKGROUND OF THE INVENTION

In general, use of Internet Protocol (IP)-based networks for delivery of video content could enable greater user control over search, selection, and playout of video content. However, users are not currently able to take advantage of this greater user control due to limitations of usability of interaction currently available to users via existing user devices. For example, usability of interaction by a user via a handheld remote control (e.g., controlling a set top box) or a handheld mobile device is limited. In particular, entry of alphanumeric data (without an alphanumeric keyboard), navigation of menus, activation of commands, and like capabilities, is notably difficult via such user devices.

Furthermore, control of multiple systems is also quite difficult via existing user devices. An existing solution that addresses the difficulty in controlling multiple systems to enjoy media content is the universal remote control. However, while the programmable universal remote control provides great ease of use, usually at the touch of a button, for well-defined functions (e.g., for predefined functions, such as watching a DVD or listening to music), the programmable universal remote control does not support less well-defined actions that require greater flexibility of user input (e.g., searching for content, ordering content, and the like).

### SUMMARY OF THE INVENTION

Various deficiencies in the prior art are addressed through the invention of a method and apparatus for searching, selecting, delivering, and presenting content to a user. In one embodiment, a method receiving content selection criteria, determining a set of candidate content items by selecting ones of a plurality of available content items using the content selection criteria, and propagating ones of the candidate content items of the set of candidate content items for presentation to the user. The entry of the content selection criteria is adapted for being controlled from a rich user interface. The presentation of the propagated ones of the candidate content items is adapted for being controlled from a simple user interface. The rich user interface and simple user interface may be part of one user device or separate user devices. The content selection criteria may include one or more rule sets, which may be defined and executed in many ways.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network;

FIG. 2 depicts one embodiment of a method for performing a content search, selection, and playout task;

FIG. 3 depicts one embodiment of a method for determining candidate content items (selecting available content items) using content selection criteria; and

FIG. 4 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention enables a content search, selection, and playout task to be performed more efficiently by a user. A complex portion of the content search, selection, and playout task is performed by the user using a rich user interface. The complex portion of the content search, selection, and playout task may include searching available content items and selecting ones of the available content items that are or may be of interest to the user. A simple portion of the content search, selection, and playout task is performed by the user using a rich user interface. The simple portion of the content search, selection, and playout task may include selection of ones of the candidate content items and playout of the selected ones of the candidate content items. The rich user interface and simple user interface may be part of one user device or separate user devices.

The present invention also enables an improved mechanism by which available content items are selected for inclusion in a set of candidate content items that are or may be of interest to a user. The mechanism by which available content items are selected for inclusion in the set of candidate content items may enable the user to provide content selection criteria (e.g., one or more rules or sets of rules) by which available content items are automatically selected for inclusion in the set of candidate content items (e.g., by application of content selection criteria to the available content items) and/or enable the user to manually search and select content for inclusion in the set of candidate content items.

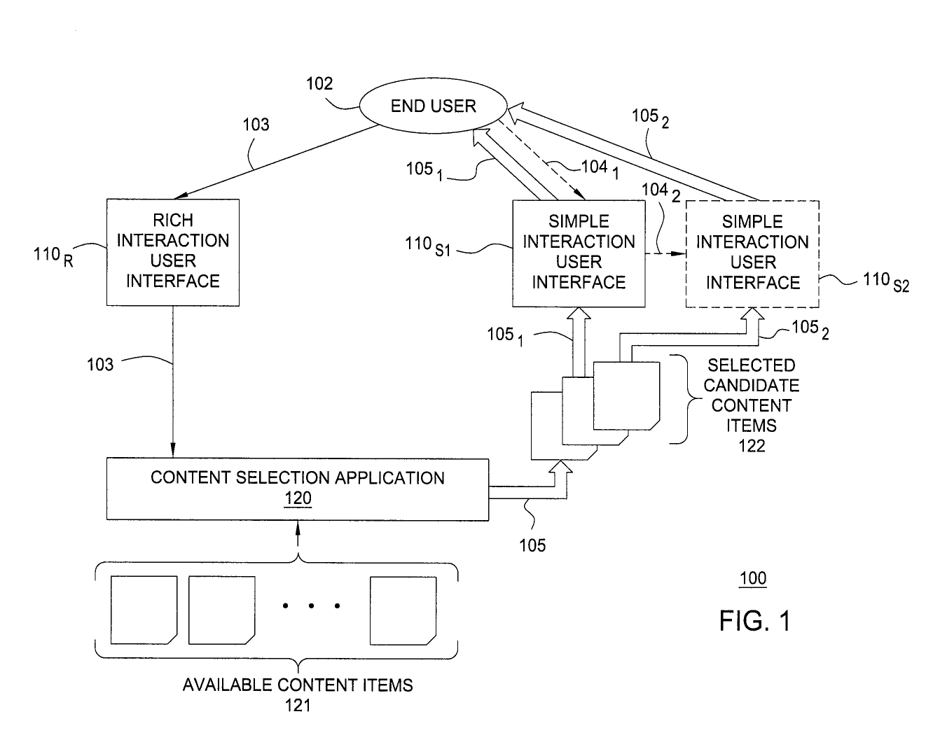

FIG. 1 depicts a high-level block diagram of an end user interaction architecture. Specifically, end user interaction architecture 100 includes an architecture within which an end user 102 performs a content search, selection, and playout task. The end user 102 utilizes one or more rich interaction user interfaces 110_{R} and one or more simple interaction user interfaces 110_{S} in order to perform different portions of the content search, selection, and playout task. The end user interaction architecture 100 includes a content selection application 120 which facilitates searching, selection, and delivery of content items in support of the content search, selection, and playout task.

The end user 102 interacts with content selection application 120 via rich interaction user interface 110_{R} in order to perform complex portions of the content search, selection, and playout task. This rich interaction between the end user 102 and content selection application 120 via rich interaction user interface 110_{R} is denoted as rich user interaction 103. The content selection application 120 facilitates selection of available content items to form thereby a set of candidate content items. The content selection application 120 also facilitates propagation of selected ones of the candidate content items toward the end user for presentation to the end user, where presentation may be performed using one or more simple interaction user interfaces 110_{S}. The end user 102 interacts with one or more simple interaction user interfaces 110_{S} in order to perform simple portions of the content search, selection, and playout task. This simple interaction between the end user 102 and the one or more simple interaction user interfaces 110_{S} is denoted as simple user interaction 104.

The end user 102 uses rich interaction user interface 110_{R} in order to perform complex portions of the content search, selection, and playout task. The complex portions of the content search, selection, and playout task may include any action or combination of actions which may result in searching of a set of content items available for selection by the end user 102 (denoted as available content items) and selection of a subset of the available content items that are or may be of interest to the end user 102 (denoted as candidate content items).

The selection of a subset of available content items to determine the candidate content items may be performed in a number of ways.

In one embodiment, selection of the subset of available content items to determine the candidate content items may be performed manually by the end user 102 (e.g., where the end user 102 manually searches the available content items and manually selects ones of the available content items).

In one embodiment, selection of the subset of available content items to determine the candidate content items may be performed automatically by the network (e.g., where the end user 102 creates and/or subscribes to content selection criteria which, when executed by the network, search the available content items and select ones of the available content items that match the content selection criteria).

In one embodiment, a combination of such content item selection techniques may be used in order to determine the set of candidate content items.

In one embodiment, for example, rich interaction user interface 110_{R} is a user interface that may support one or more of alphanumeric data entry using a keyboard, selection of actions from a menu or clicking on buttons or other objects on a screen using a pointing device (e.g., mouse, trackball, and the like), and the like, as well as various combinations thereof. For example, rich interaction user interface 110_{R} may be an interface associated with a desktop computer, a laptop computer, or any other similar device enabling the user to perform complex actions.

The end user 102 uses one or more simple interaction user interfaces 110_{S} (illustratively, 110_{S1} and, optionally, 110_{S2}) in order to perform simple portions of the content search, selection, and playout task. The simple portions of the content search, selection, and playout task may include any action or combination of actions which may result in selection of ones of the candidate content items for delivery to end user 102 and control of the playout of the selected ones of the candidate content items delivered to end user 102 (e.g., starting playout, stopping playout, cancelling playout, executing trick play functions, and the like).

In one embodiment, for example, simple interaction user interfaces 110_{S} include user interfaces that have restricted user interaction capabilities. For example, a simple interaction user interfaces 110_{S} may include one or more of at least one means for navigating horizontally and vertically through choices, at least one function-specific button, and the like (e.g., a numeric keypad, one or more multipurpose keypads, one or more function-specific buttons, small and/or low-resolution screens, and the like, as well as various combinations thereof). For example, simple interaction user interfaces 110_{S} may include interfaces associated with a cellular phone, a personal data assistant, a remote control and one or more associated user devices being controlled by the remote control (e.g., a universal remote controlling multiple components of a home entertainment system, a set top box remote controlling a set top box and associated television, and the like), or any other similar device(s) restricting the user to performing simple actions.

In one embodiment, rich interaction user interface 110_{R} and simple interaction user interface(s) 110_{S} may be part of one user device. In one such embodiment, for example, rich interaction user interface 110_{R} and simple interaction user interface(s) 110_{S} may be part of a computer, where the, rich interaction user interface 110_{R} includes the keyboard and mouse for controlling entry of content selection criteria and the simple interaction user interface(s) 110_{S} includes a simple remote control device for controlling selection and playout of content on the computer monitor.

In one embodiment, rich interaction user interface 110_{R} and simple interaction user interface(s) 110_{S} may be part of separate user devices. In this embodiment, for example, rich interaction user interface 110_{R} may be part of a desktop computer, a laptop computer and the like. In this embodiment, for example, simple interaction user interface(s) 110_{S} may be one or more of a remote control, a cellular phone, a PDA, and the like.

As depicted in FIG. 1, simple portions of the content search, selection, and playout task may be performed using one simple interaction user interface or multiple simple interaction user interfaces (e.g., where one of the simple interaction user interfaces controls one or more other simple interaction user interfaces or devices).

In one embodiment, both selection and playout of candidate content items is performed using one device (e.g., where a cellular phone, PDA, or other similar user device is used). For example, ones of the candidate content items are selected by end user 102 via simple interaction user device 110_{S1} (via simple user interaction 104₁) and the selected ones of the candidate content items are delivered to simple interaction user device 110_{S1} (content delivery 105₁) for playout to end user 102.

In another embodiment, selection and playout of candidate content items is performed using multiple devices (e.g., where a universal remote is used to control a television or any other similar user devices are used). For example, ones of the candidate content items are selected by end user 102 using both simple interaction user devices 110_{S1} (via simple user interaction 104₁, e.g., via interaction of the end user 102 with a universal remote) and 110_{S2} (via simple user interaction 104₂, e.g., interaction from the universal remote to a television), and the selected ones of the candidate content items are delivered to simple interaction user device 110_{S2} (content delivery 105₂, e.g., to the television) for playout to end user 102 where playout is controlled via simple user interactions 104₁ and 104₂).

As described herein, the content selection application 120 facilitates searching of a set of available content items (which, as described herein, are denoted as available content items 121) in order to select a subset of the available content items which are or may be of interest to end user 102 (which, as described herein, are denoted as selected content items 122). The content items may include any content items (e.g., data files, audio content, video content, multimedia content, and the like, as well as various combinations thereof).

As described herein, searching and selecting of available content items 121 in order to determine candidate content items 122 may be performed manually by end user 102 using content selection application 120 (e.g., using search and selection operations in which the end user 102 selects specific ones of the available content items 121) and/or automatically by content selection application 120 (e.g., based on content selection criteria defined by end user 102 and/or subscribed to by end user 102).

Although primarily depicted and described herein with respect to an embodiment in which the end user 102 uses one rich interaction user interface and one or two simple interaction user interfaces in order to perform the content search, selection, and playout task, end user 102 may use other numbers of rich interaction user interfaces and simple interaction user interfaces to perform the content search, selection, and playout task. Although primarily depicted and described herein with respect to an embodiment in which one content selection application facilitates the content search, selection, and playout task, multiple content selection applications may facilitate the content search, selection, and playout task using any numbers and types of content sources.

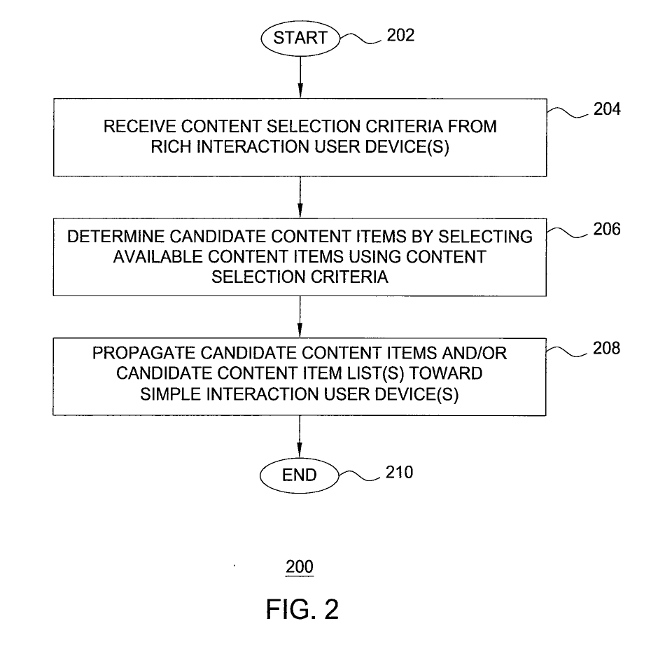

FIG. 2 depicts a method according to one embodiment of the present invention. Specifically, method 200 of FIG. 2 includes a method for performing the content search, selection, and playout task. Although depicted and described as being performed serially, at least a portion of the steps of method 200 may be performed contemporaneously, or in a different order than depicted and described with respect to FIG. 2. The method 200 begins at step 202 and proceeds to step 204.

At step 204, content selection criteria are received from one or more rich interaction user devices (i.e., from one or more user devices having one or more rich interaction user interfaces). The content selection criteria are received based on rich interaction between the user and the rich interaction user device. The content selection criteria may be manual selections of available content items and/or manual definition of one or more rules (e.g., one or more new rules created by an end user and/or one or more existing rules selected by the end user) which, when executed, result in selections of available content items.

In one embodiment, content selection criteria received from the rich interaction user device(s) may be supplemented with additional content selection criteria. For example, additional content selection criteria may be received at the content selection application from other sources, inferred by the content selection application (e.g., from the received content selection criteria, from other forms of explicit and/or implicit user input), and the like), as well as various combinations thereof.

At step 206, candidate content items are determined using the content selection criteria. The candidate content items are determined by selecting ones of the available content items using the content selection criteria. Where the content selection criteria are manual selections of available content items, the candidate content items are determined directly from the selections specified by the end user. Where the content selection criteria are one or more rules, the candidate content items are determined by executing the rules against the available content items.

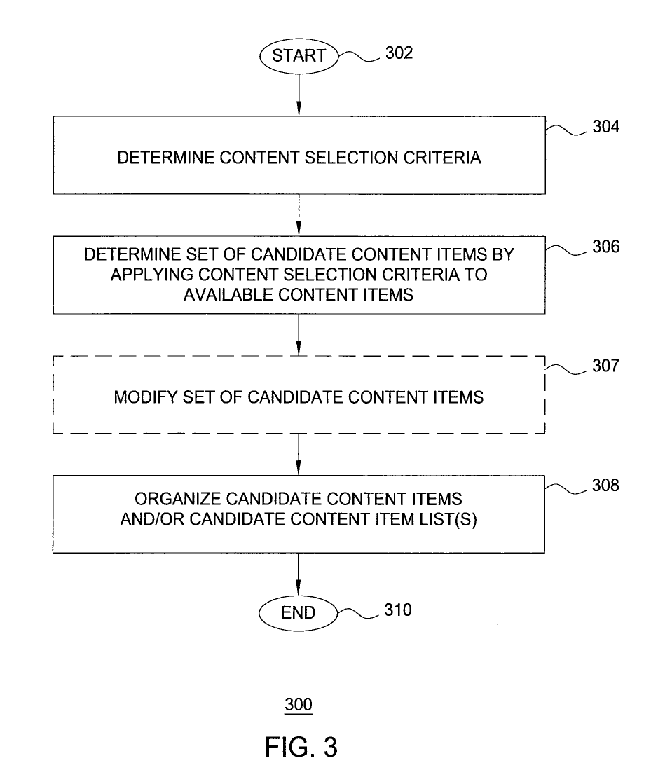

In one embodiment, steps 204 and 206 may be performed as depicted and described herein with respect to FIG. 3

At step 208, candidate content items, and/or one or more candidate content item lists providing an index to the candidate content items, are propagated toward one or more simple interaction user devices (i.e., to one or more user devices having one or more simple interaction user interfaces). The candidate content items and/or candidate content item lists may be propagated to the simple interaction user device(s) in many ways.

In one embodiment, a list (or lists) of the candidate content items is propagated to the simple interaction user device(s) before the candidate content items are propagated to the simple interaction user device. The list of candidate content items is presented to the user. The list of candidate content items may be organized in any manner (e.g., sequentially based on non-time factors, based on time factors, and the like, as well as various combinations thereof). Upon selection, by the user, of one or more of the candidate content items, the selected ones of the candidate content items are delivered to the simple interaction user device(s) for playout to the user. The selected ones of the candidate content items may be propagated to the simple interaction user device(s) in any order (where the order may be determined in any manner). The playout to the user may be immediate (e.g., as the selected candidate content item is received) or delayed (e.g., where the candidate content item is stored locally for later playout to the user). This embodiment may be used where storage space on the simple interaction user device(s) is limited.

In one embodiment, the candidate content items are propagated to the simple interaction user device(s) immediately (e.g., following selection of ones of the available content items based on the content selection criteria). The candidate content items may be propagated to the simple interaction user device(s) in any order (where the order may be determined in any manner, e.g., sequentially based on non-time factors, based on time factors, and the like, as well as various combinations thereof). In one embodiment, playout of candidate content items may be performed as the candidate content items are received. In one embodiment, a list of candidate content items stored on the simple interaction user device(s) is presented to the user and, upon selection, by the user, of one of the candidate content items, the selected one of the candidate content items is retrieved locally from the simple interaction user device(s) for playout to the user (upon selection by the end user via the simple interaction user device(s)). This embodiment may be used where storage space on the simple interaction user device(s) is not an issue.

In other words, candidate content items may be stored in the network, on one or more simple interaction user devices, and the like, as well as various combinations thereof. The propagation of the candidate content items may be in any order (which may be determined using any factor or combination of factors). For example, candidate content items may be propagated to the user device in an order that is based and/or is not based on the determined organization of the candidate content items (e.g., the first few candidate content items are propagated to the user device based on the order of the organized candidate content items and the remaining content items are propagated to the user device in a random order or an order based on some other factor(s)). The playout of candidate content items may be automatic (e.g., as soon as the user activates the simple interaction user device, playout of candidate content items begins). The playout of candidate content items may be manual (e.g., the user is presented with a list of candidate content items such that playout of candidate content items is based on manual user selections). The delivery and playout of candidate content items via one or more simple interaction user device(s) may be performed in other ways.

At step 210, method 200 ends. Although depicted and described as ending (for purposes of clarity), the different steps of method 200 of FIG. 2 may be repeated in order to modify or refine the content selection criteria and, thus, modify or refine the subset of the available content items that are selected for the end user and ultimately delivered to the simple interaction user device(s) for playout to the end user via the simple interaction user device(s). Thus, repetition of method 200 may occur in response to any conditions and/or events (e.g., when the selection of a new set of candidate content items is possible because the selection rules have changed, or if the user wants to search for a specific content item, or because one or more new content items have been added to the set of available content items, and the like, as well as various combinations thereof).

As described herein, the simple interaction user interface(s) and rich interaction user interface(s) may be part of one user device or separate user devices. As such, references in FIG. 2 to the rich interaction user device(s) and simple interaction user device(s) may be references to different user interfaces of one user device and/or different user interfaces of different user devices.

As described herein, a content selection and organization mechanism is provided, where the content selection and organization mechanism may be used within the context of the architecture of FIG. 1 or independent of the architecture of FIG. 1. The content selection and organization mechanism enables selection of candidate content items from a set of available content items, where the resulting set of candidate content items includes content items that are or may be of interest to one or more users. The content selection and organization mechanism may be better understood with respect to FIG. 3.

FIG. 3 depicts a method according to one embodiment of the present invention. Specifically, method 300 of FIG. 3 includes a method for determining candidate content items (selecting available content items) and organizing the candidate content items. Although depicted and described as being performed serially, at least a portion of the steps of method 300 may be performed contemporaneously, or in a different order than depicted and described with respect to FIG. 3. The method 300 begins at step 302 and proceeds to step 304.

At step 304, content selection criteria are determined. The content selection criteria may be determined explicitly (e.g., based on information received from one or more users) and/or implicitly (e.g., based on observation of the behavior of one or more users).

The content selection criteria may include specific content items selected by the user. The content selection criteria may include one or more rules or sets of rules. A rule may include one or more rule criteria. A set of rules includes rule criteria of the rules of which the set of rules is composed. A rule (and, thus, a rule set) may be defined in various different ways.

A rule set may be defined by an individual user. A rule set may be collaboratively defined by a set of users.

A rule set may be defined explicitly by a user or users.

A rule set may be defined explicitly (e.g., through a menu, text input box, or any other input entry means) based on one or more of entry of one or more content selection factors by the user, feedback information entered by the user for content presented to the user, and a seed content item indicative of content preferred by the user, and the like, as well as various combinations thereof.

For example, content selection factors entered by the user may include one or more of a preferred content genre, a disfavored content genre, a critical rating, a popularity rating, a release date of the content item, a value associated with proposing a content item, an appropriate age classification, an index of similarity to items preferred by one or more other users, an index of similarity to content items disfavored by one or more other users, a degree of match between tags associated with content items and tags selected by the user, a preferred actor, and a disfavored actor, and the like, as well as various combinations thereof.

For example, feedback from the user for content items presented to the user may include one or more of a rating on a four star scale, a “thumbs-up” or “thumbs-down” rating, and the like, as well as various combinations thereof.

A rule set may be defined by inference from one or more “test case” content items rated by the user or users.

A rule set may be defined implicitly.

A rule set may be defined implicitly based on an observation of user behavior. For example, a rule set may be defined based on observation of which content items the user chooses to watch, chooses to not watch, chooses to abandon part way through watching, requests additional information on (e.g., reads a summary of the plot), and the like.

A rule set may be persistent. A persistent rule set may continuously operate to detect relevant content items over an extended period of time. For example, content items matching the rules of the rule set are detected as those content items become available. This may also be referred to herein as an “agent” rule set.

A rule set may be ac hoc and transient. For example, a temporary rule set may be defined to search for content items based on current interests that are not expected to be relevant in the future. This may also be referred to herein as a “search” rule set. A transient rule set may be configured to expire at a certain time or after a certain length of time. A transient rule set may be converted into a persistent rule set.

A rule set may assign a “strength of match” attribute to each content item, where the “strength of match” attribute is indicative of how strongly the associated content item matches the rule criteria. For example, a content item may match a genre category (e.g., comedy movie), but may do so very weakly (e.g., the comedy movie is not very funny). A match may have both positive (like) and negative (dislike) polarity.

A rule set may classify a content item into one of multiple defined “match” categories (e.g., “strong match”, “weak match”, and “no match”).

A rule set may assign a “confidence” attribute to each content item, where the “confidence” attribute is indicative of a degree of certainty associated with the match (e.g., a degree of certainty with respect to the “strength of match” attribute assigned to the content item, a degree of certainty with respect to the “match” category to which the content item is assigned, and the like). For example, a content item with multiple pieces of matching information may be assigned a higher confidence rating than a content item with only one piece of matching information.

A rule set may assign a “polarity of match” attribute to each content item, where the polarity of match attribute is indicative of a positive or negative association associated with the strength of match attribute assigned to the content item.

A rule set may be defined using any combination of the options described herein. A rule set may be defined using various other options for specifying content selection criteria that are not specifically described herein.

A rule set may be published by a user or group of users (e.g., for use by other users).

A rule set may be subscribed to by a user. (e.g., a user may subscribe to one or more existing rule sets, in place of or in addition to defining one or more new rule sets). For example, a user may subscribe to an existing agent rule set defined and published by another user or set of users, an expert (e.g., Roger Ebert's top picks), a celebrity (e.g., Oprah's top picks), and the like.

A rule set may be modified any time after being defined.

Although primarily described with respect to the manner in which a rule set is defined, an individual rule may be defined in a similar manner.

At step 306, the content selection criteria are applied to a set of available content items in order to determine a set of candidate content items.

The content selection criteria may be applied to the available content items in any manner. In one embodiment, in which the content selection criteria include one or more rule sets, application of the content selection criteria includes execution of the one or more rule sets against the available content items to produce therefrom the candidate content items. The rule sets may be applied in any manner.

The rule sets may be applied in parallel, sequentially, hierarchically, and the like, as well as various combinations thereof.

In one embodiment, in which rule sets are applied in parallel, the rule sets may be applied in parallel in any manner. Any number of rule sets may be applied in parallel. For example, two rule sets may be applied in parallel. For example, ten rule sets may be applied in parallel.

In one embodiment, in which rule sets are applied sequentially, a secondary rule set searches for matching content items within a set of content items selected by a primary rule set. Any number of rule sets may be applied sequentially. For example, two rule sets may be applied sequentially. For example, ten rule sets may be applied sequentially. In such embodiments, adjacent rule sets may be referred to as primary and secondary rule sets (i.e., a secondary rule set is applied against the results of a primary rule set).

For example, a secondary rule set may be applied to search for matching content items in a set of content items that includes any content items assigned one or more particular “match” categories after execution of a primary rule set (e.g., the secondary rule set is applied against a set of content items deemed by the primary rule set to be “strong match” items and “weak match” items).

For example, a secondary rule set may be applied to search for matching content items in a set of content items that includes any content item having a “strength of match” value (determined by execution of the primary rule set) that satisfies a particular threshold (e.g., the secondary rule set is applied against a set of content items deemed by the primary rule set to have a very high “strength of match” value).

A secondary rule set may be applied to a set of content items produced by a primary rule set in any other manner.

In one embodiment, in which rule sets are applied hierarchically, rule sets are applied using any combination of parallel application and sequential application.

For example, five rule sets may be applied as follows: apply a first rule set; apply a second rule set and a third rule set, in parallel, against the results of the first rule set; and apply a fourth rule set and a fifth rule set, in parallel, against the results of the parallel application of the second and third rule sets.

For example, seven rule sets may be applied as follows: apply a first rule set, a second rule set, and a third rule set in parallel; and apply a fourth rule set against the results of the parallel application of the first, second, and third rule sets.

The rule sets may be applied hierarchically in any other manner.

The rule sets may be applied periodically (e.g., once each hour, once each day, and the like)

The rule sets may be applied aperiodically (e.g., in response to one or more trigger conditions). The trigger condition may be modification of the rule set (e.g., addition of a rule or rule criteria, deletion of a rule or rule criteria, modification of a rule or rule criteria, and the like), availability of new content items (e.g., any time a new content item becomes available, after a threshold number of new content items become available, and so forth), and the like, as well as various combinations thereof.

The application of the rule set(s) to the available content items results in selection of ones of the available content items (thereby forming the set of candidate content items).

A content item may be included as a candidate content item or excluded as a candidate content item based on a number of factors.

A content item may be included as a candidate content item or excluded as a candidate content item based on any of the criteria, attributes, rules, and like factors described herein.

A content item may be included if it matches one or more rule sets and doesn't match one or more other rule sets.

A content item may be included if it matches a certain number of rule sets executed against the available content items. For example, a content item may be included if it matches any one of multiple rule sets executed against the available content items, if it matches each of multiple rule sets executed against the available content items, if it matches a threshold number of rule sets out of a total number of rule sets executed against the available content items, and the like.

At step 307 (an optional step), the set of candidate content items may be modified. This enables the user to manually modify the content items included in the set of candidate content items. For example, the user can prune the list of candidate content items (e.g., where content items not of interest to the user inadvertently slipped through the selection criteria), supplement the list of candidate content items (where content items of interest to the user were inadvertently omitted due to the selection criteria), and the like, as well as various combinations thereof.

At step 308, the candidate content items are organized and/or the list or lists of candidate content items are organized.

In one embodiment, in which at least some of the candidate content items included in the set of candidate content items are propagated toward the user automatically, propagation of the candidate content items in the set of candidate content items may be organized in many ways (such that the candidate content items are propagated to the user according to some organizational scheme).

In one embodiment, in which at least one list of candidate content items is propagated to the user (e.g., before propagation of candidate content items selected by the user and/or contemporaneously with propagation of at least some of the candidate content items automatically), the candidate content items included in the list(s) of candidate content items may be organized in many ways.

Thus, since (1) propagation of candidate content items may be organized and/or (2) one or more lists of candidate content items may be organized, the following description of organizational options by which such organization may be controlled is primarily described within the context of organizing candidate content items. The candidate content items may be organized in many ways.

The content items may be organized sequentially (as a non-temporal sequence or sequences).

The content items may be organized into one or more sequential lists of content items selected from the set of selected content items (i.e., from the content items selected using the content selection criteria). The content items may be organized into one or more sequential lists in a number of ways. The content items may be organized within a sequential list. The content items within a sequential list may be organized in a number of ways.

The content items may be organized based on a simple match to one rule set or based on matches to multiple rule sets.

The content items may be organized based on a number of rule sets matched by each content item. For example, content items satisfying a larger number of the executed rule sets are ranked ahead of content items satisfying a smaller number of the executed rule sets.

The content items may be organized by randomly mixing content items selected based on execution of different rule sets.

The content items may be organized by interleaving content items selected based on execution of different rule sets.

The content items may be drawn from the different rule sets evenly. For example, selecting a content item from a rule set associated with “comedy”, selecting a content item from a rule set associated with “action”, selecting a content item from a rule set associated with “romance”, selecting another content item from the rule set associated with “comedy”, and so forth.

The content items may be drawn from the different rule sets unevenly. In one embodiment, content items may be drawn from different rule sets unevenly based on defined weightings applied to different rule sets. For example, 60% of the content items may be selected based on execution of a rule set associated with “comedy” content and the other 40% of the content items may be selected randomly based on execution of one or more other rule sets.

The content items drawn from different rule sets may be organized in various other ways.

The content items drawn from different rule sets may be organized using additional rules specifying organization of content items selected based on different rule sets (e.g., content items selected based on execution of certain rule sets must precede content items selected based on execution of other rule sets, content items selected based on execution of certain rule sets must follow content items selected based on execution of other rule sets, and the like).

For example, where four rule sets (A, B, C, D) are executed to determine the selected content items, the selected content items may be organized such that 1) content items from rule set C never directly follow content items from rule set A, 2) content items from rule set B must always be preceded by content items from rule set A; and 3) content items from rule set D must always be within four positions of a content item from rule set B and within three positions of a content item from rule set A.

The content items may be organized to reflect the preferences of one user or a combination of preferences of multiple users (e.g., based on rankings of genres, actors, and like characteristics). For example, comedy-based content items may be listed first, followed by action-based content items, and so forth. For example, content items including Tom Hanks may be ranked first, followed by sports-based content items, and so forth.

The content items may be organized based on one or more attributes associated with the content items (e.g., based on one or more of “strength of match”, “match category”, “confidence”, and the like). For example, content items may be organized based on similarity of “match category”, and then further organized in order of “confidence” within each “match category”. The attributes may be applied in various other ways.

The content items may be organized temporally (as a sequence in time). A content item that is organized temporally may be constrained with respect to its placement in time. The duration of a content item may be a factor in its temporal organization.

The content items may be organized using a mix of sequential and temporal organization (e.g., where certain content items are fixed in time and other content items are not fixed in time but, rather, are sorted into some sequence).

In one embodiment, the candidate content items may be further filtered into one or more shortlists. A shortlist may be determined using one or more factors, which may include any of the attributes, rules, or other factors described herein, or any other factors which may be used to filter the candidate content items to form one or more shortlists.

For example, a shortlist may be generated based on the current mood of the user, the current preferences of the user for particular genres, the amount of time that the user has available to watch content items, the type of audience that is in the room with the user, and the like, as well as various combinations thereof.

For example, a shortlist may be generated based on which rule set(s) caused the available content items to be selected as candidate content items, “strength of match” values of the candidate content items, “confidence” values of the candidate content items, content item descriptors (e.g., content item duration, content item genre, and/or any other descriptors), and the like, as well as various combinations thereof.

At step 310, method 300 ends. Although depicted and described as ending (for purposes of clarity), the candidate content items or list(s) of candidate content items are propagated to one or more user devices for playout to the user. The candidate content items may be propagated to the user device(s) in any manner (e.g., immediately based on execution of the rule set(s), based on selections by the user via the user device(s), and the like). The candidate content items or list(s) of candidate content items may be propagated to the user device in an order based on the determined organization of the candidate content items and/or not based on the determined organization of the candidate content items (e.g., the first few candidate content items are propagated to the user device based on the order of the organized candidate content items and the remaining content items are propagated to the user device in a random order or an order based on some other factor(s)). The candidate content items received at the user device may be played out to the user in any manner.

The operation of the different mechanisms depicted and described herein may be better understood with respect to some examples.

In a first example, a user goes to his PC and browses a list of available agent rule sets, where a rule set is a pattern or a set of criteria for the automated discovery of interesting content and “agent” is indicative that the system actively and continually searching for such content on behalf of a user This can be contrasted with a “search” rule set which is a set of criteria defined by a user to select or iteratively refine a set of content at a single point in time. The user reviews agent rule set selection information associated with agent rule sets (e.g., such as subscription popularity, descriptions, personal recommendations, and the like). The user selects some of the available agent rule sets that are of interest to him based on the agent rule sets selection information. In this manner, the user defines content selection criteria, which may include one or more rule agent rule sets.

In continuation of this example, assume that the user selects one “expert” agent rule set (e.g., Roger Ebert's Top Picks), one “community of interest” agent rule set (e.g., SciFi Lovers), and one “celebrity” agent rule set (e.g., Oprah's Romantic Comedies). These agent rule sets selected by the user operate as content selection criteria, and may be applied against available content items in any manner (e.g., individually, in combination, and the like).

The selection of available content items based on an agent rule set results in a set of candidate content items (e.g., one or more lists of candidate content items, which may also be referred to as a content pipeline(s)). For example, where the three agent rule sets are applied individually, selection of content items based on the Roger Ebert agent rule set results in a Roger Ebert content pipeline, selection of content items based on the SciFi Lovers agent rule set results in a SciFi Lovers content pipeline, and selection of content items based on the Oprah's Romantic Comedies agent rule set results in an Oprah's Romantic Comedy content pipeline.

In continuation of this example, assume that the “Roger Ebert” agent rule set accesses premium content. The user is prompted with an option to determine whether he would like to pay an additional $6/month to have advertisement-free access to the content or whether he would like to access the content for free with three minutes of pre-viewing advertisements. The user chooses to pay the $6/month.

In continuation of this example, the user specifies a merge subscription operation using the Roger Ebert agent rule set and the SciFi Lovers agent rule set, meaning either that an available content item must meet the criteria of both agent rule sets in order to be selected as a candidate content item or that a candidate content item must meet the criteria of both agent rule sets in order to be selected for delivery to the user.

In continuation of this example, the user specifies a shuffle subscription on the Oprah's Romantic Comedies agent rule set, specifying that he would like 30% of candidate content items to be selected based on the Oprah's Romantic Comedies agent rule set (e.g., randomly alternating with the other 70% of the candidate content items, which are selected based on the merged combination of the Roger Ebert and the SciFi Lovers agent rule sets).

In continuation of this example, starting from combined agent agent rule set criteria (e.g., such as the one described hereinabove), the user may add one or more content filtering rules adapted to further refine content selection. The additional content filtering rules may further refine one or more individual agent rule sets previous selected by the user, or may be generic rules applied across all agent rule sets selected by the user. The content filtering rules may be defined as one or more agent rule sets.

For example, assume that the user adds a first content filtering rule that any content item that includes “Adam Sandler” in actor metadata of the content item should be excluded.

For example, assume that the user adds a second content filtering rule that all content items that he has viewed within the past year and which he has given a positive rating should be excluded and, further, that all previously viewed content items that he has given a negative rating should be excluded. In other words, based on this second rule, content items that the user liked may be suggested again if at least a year has passed since the last time the user viewed the content item.

As described herein, this combination of agent rule sets, subscriptions (e.g., merge subscriptions, shuffle subscriptions, and the like), and content filtering rules defines a personal agent (i.e., the content selection criteria) for the user. The user may modify this personal agent as often as he likes, and in any manner he likes (e.g., adding or removing agent rule sets; adding, modifying, and removing subscription functions; adding, modifying, and removing content filtering rules; and the like, as well as various combinations thereof).

The personal agent is executed in response to one or more personal agent execution events (i.e., any event which triggers application of the content selection criteria to available content items in order to determine the set of candidate content items). The personal agent is run against a library of available content items to select ones of the available content items as candidate content items from which the user may produce a personal content pipeline. For example, the personal content pipeline may include all candidate content items (where each candidate content item is automatically delivered to the user) or one or more lists of the candidate content items such that the user may manually select which candidate content items are delivered to the user (e.g., where each candidate content item is not just automatically delivered to the user without any input from the user).

The personal agent execution events may include initial creation of the personal agent, modification of the personal agent, availability of new content items, and the like, as well as various combinations thereof. The modification of the personal agent may be a result of explicit feedback provided by the user (e.g., where the user explicitly signals likes, dislikes, interests, and any other explicit feedback), implicit feedback associated with the user (e.g., based on content consumption habits of the user, browsing of available content by the user, and any other implicit feedback), and the like, as well as various combinations thereof.

The user may manually modify the personal content pipeline (i.e., modify the list(s) of candidate content items). For example, the user may remove content items, add content items, reorder content items, and the like. For example, the user may remove content items from the personal content pipeline (e.g., where the user is uninterested in certain content items selected by the personal agent). For example, the user may add real-time content items to the personal content pipeline. The user may modify the personal content pipeline in other ways.

In continuation of this example, the user adds three different categories of real-time content to his personal content pipeline such that content items from these categories of real-time content are scheduled into his personal content pipeline as the content items become available.

The first category includes any live performance by Evanescence, and the user specifies that the content items in this category should be scheduled into the personal content pipeline and, if not watched, the content items should be saved and proposed at a later time.

The second category includes any live game by the Chicago Bulls, and the user specifies that the content items in this category should be scheduled into the personal content pipeline and, if not watched, the content items should be saved and proposed at a later time.

The third category includes the local 11 PM news, and the user specifies that the content items in this category should be scheduled into the personal content pipeline and, if not watched, the content items should be not be proposed at a later time.

The user may then playout content items from the personal content pipeline (e.g., using one or more user devices, which may include simple interaction user devices).

In continuation of this example, the user accesses his personal content pipeline on his home entertainment system. The user turns on his television system using his universal remote control.

In one embodiment, the list of candidate content items of the personal content pipeline is presented to the user, and the user selects one or more of the candidate content items of the personal content pipeline and the selected content item(s) are presented.

In one embodiment, the content items of the personal content pipeline are presented to the user (e.g., the content items satisfying the criteria of the personal agent are automatically scheduled for the user).

The user may control the presentation of the content items in any manner, including control of the personal content pipeline and control of individual content items of the personal content pipeline.

For example, the user may control the personal content pipeline by selecting one or more content items to be presented, skipping to new content items, returning to previous content items, canceling one or more content items, and performing like control functions, as well as various combinations thereof. The user may control the personal content pipeline in various other ways.

For example, the user may control individual content items of the personal content pipeline by starting, stopping, fast-forwarding, pausing, rewinding, controlling sound volume, and performing like control functions, as well as various combinations thereof. The user may control each individual content item of the personal content pipeline in various other ways.

The user may temporarily override the personal agent criteria.

For example, the user may specify, via the remote control, that he only wants content items satisfying the criteria of the Oprah's Romantic Comedies agent rule set, thereby resulting in an Oprah's Romantic Comedies content pipeline.

For example, the user may specify, via the remote control, that he doesn't want the local 11 PM news to be scheduled into his personal content pipeline tonight because there is a lot of other content that he would prefer to watch.

The user may perform various other control operations, such as providing feedback on content items, signaling which viewers are in the room (e.g., whether or not children are present so that appropriate programming is presented), signaling preferred mood/genre/pipeline, signaling an amount of time that the user has available for viewing content, and the like, as well as various combinations thereof.

In a second example, a user goes to her laptop and enters an ad-hoc search for available content items. The ad-hoc search includes any content items which include “Sandra Bulloch” in actor metadata and which have a popularity rating of greater than 3 stars out of 5 stars. The ad-hoc search excludes any content items that include the word “Speed” within user-defined tags.

In this example, execution of the ad-hoc search results in an instant content pipeline including candidate content items that meet the specified content search criteria. The instant content pipeline is a list of candidate content items which meet the criteria specified by the user in the ad hoc search.

In one embodiment, the list of candidate content items of the instant content pipeline may be an ordered list of content items. The list of candidate content items may be ordered using any information. For example, candidate content items may be ordered based on relevance of the content items to the criteria of the personal agent (e.g., content items having a popularity rating of 5 stars may be listed before content items having a popularity rating of 4 stars). For example, candidate content items may be ordered based on time (e.g., ordered based on the date of release of each of the candidate content items). The order of the candidate content items may be set in many other ways.

The user may then playout content items from the instant content pipeline using one or more user devices, which may include one or more simple interaction user devices.

In continuation of this example, the user accesses her instant content pipeline on her video-capable 3G cell phone. The user turns on her cell phone. The user is presented with the list of the candidate content items of the instant content pipeline. The user selects one or more of the candidate content items of the instant content pipeline and the selected content item(s) are presented.

The user controls presentation of the selected content item(s) using standard controls on the cell phone.

In continuation of this example, assuming that the user is happy with her instant content pipeline experience, the user may decide to publish her search criteria as a personal agent rule set. In this case, the user may then share the published personal agent rule set with her friends (e.g., by emailing a link to the personal agent rule set to her friends).

In continuation of this example, assume that the user and her friends decide to expand on the search criteria of the personal agent rule set (e.g., to include other actors that they like). For example, the user and her friends may work collaboratively to further define the shared agent rule set (e.g., by allowing other actors in the actor metadata). The user and her friends may refine the shared agent rule set in various other ways. In this manner, content selection criteria may be established for a group of users, and may then be used by any of the users in the group.

In continuation of this example, assume that, by allowing additional actors, poor quality content items are being included in the resulting instant content pipeline (i.e., due to insufficient precision in the rules of the shared agent rule set). In this case, the user and her friends may specifically exclude these poor quality content items such that they are not included in the instant content pipeline (e.g., as per step 307 of method 300).

These examples are merely provided for illustrative purposes and are not intended to limit any of the content search, selection, delivery, or playout functions depicted and described herein.

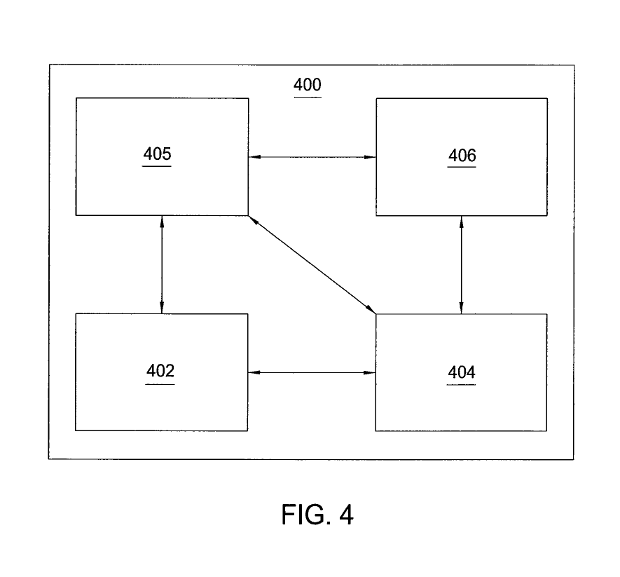

FIG. 4 depicts a high-level block diagram of a general-purpose computer suitable for use in performing the functions described herein. As depicted in FIG. 4, system 400 comprises a processor element 402 (e.g., a CPU), a memory 404, e.g., random access memory (RAM) and/or read only memory (ROM), a content selection module 405, and various input/output devices 406 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present content selection process 405 can be loaded into memory 404 and executed by processor 402 to implement the functions as discussed above. As such, content selection process 405 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for discovering, searching, selecting, and propagating content for a user, comprising:
receiving content selection criteria, wherein entry of the content selection criteria is adapted for being controlled from a rich user interface;
determining a set of candidate content items by selecting ones of a plurality of available content items using the content selection criteria; and
propagating ones of the candidate content items of the set of candidate content items for presentation to the user, wherein presentation of the propagated ones of the candidate content items is adapted for being controlled from a simple user interface.

2. The method of claim 1, wherein the user controls entry of the content selection criteria via the rich user interface, wherein the user controls presentation of the propagated ones of the candidate content items via the simple user interface.

3. The method of claim 1, wherein the first user interface and the second user interface are associated with one user device.

4. The method of claim 1, wherein the first user interface is associated with a first user device and the second user interface is associated with a second user device.

5. The method of claim 4, wherein the first user device comprises a computer and the second user device comprises at least one of a remote control, a cellular phone, a personal data assistant, and a television system.

6. The method of claim 1, wherein the rich user interface comprises at least one of an alphanumeric keyboard and a pointing device.

7. The method of claim 1, wherein the simple user interface comprises at least one of at least one means for navigating horizontally and vertically through choices and at least one function specific button.

8. The method of claim 1, wherein the content selection criteria comprises a rule set.

9. The method of claim 8, wherein the rule set is defined at least one of:
explicitly using at least one of a content selection factor entered by the user, feedback information entered by the user for content presented to the user, and a seed content item indicative of content preferred by the user; and
implicitly using at least one of observation of content viewing behavior of the user and feedback information entered by the user for content presented to the user.

10. The method of claim 8, wherein the rule set comprises at least one of a persistent rule set and a temporary rule set.

11. The method of claim 8, wherein the rule set comprises a rule set to which the user subscribes.

12. The method of claim 8, wherein, for each of the candidate content items, the rule set assigns at least one of:
a strength of match attribute indicative of a strength with which the candidate content item matches the rule set; and
a polarity of match attribute indicative of a positive or negative association.

13. The method of claim 1, wherein the content selection criteria comprises a plurality of rule sets, wherein determining the set of candidate content items using the content selection criteria comprises:
executing the rule sets against the available content items.

14. The method of claim 13, wherein the rule sets are executed at least one of sequentially, in parallel, hierarchically, periodically, and in response to an event.

15. The method of claim 13, wherein one of the available content items is selected as one of the candidate content items only if matching more than one of the rule sets.

16. The method of claim 1, further comprising:
modifying the set of candidate content items based on information received from the user.

17. The method of claim 1, further comprising:
organizing the candidate content items of the set of candidate content items using at least one of

18. The method of claim 17, wherein the candidate content items are organized at least one of sequentially and temporally.

19. The method of claim 17, wherein, when the candidate content items are organized into at least one sequential list of candidate content items, the candidate content items are organized by at least one of:
interleaving candidate content items matching different ones of a plurality of rule sets, wherein the candidate content items may be interleaved proportionally or disproportionately;
randomly mixing candidate content items matching different ones of a plurality of rule sets; or
using at least one organization rule adapted for determining placement of candidate content items based on which rule set caused the candidate content item to be selected.

20. The method of claim 17, wherein the candidate content items are ordered within a list based on at least one of a current mood of the user, a currently preferred genre of the user, a currently preferred actor of the user, a length of time available to the user to review content, a type of audience with which the user will review content, and at least one matching attribute associated with each of the candidate content items.

21. The method of claim 1, further comprising:
prior to propagating the ones of the candidate content items for presentation to the user, propagating a list of the candidate content items for presentation to the user;
wherein the ones of the candidate content items are propagated for presentation to the user upon selection of ones of the candidate content items from the list of candidate content items via the simple user interface.

22. An apparatus for discovering, searching, selecting, and propagating content to a user, the apparatus comprising:
means for receiving content selection criteria, wherein entry of the content selection criteria is adapted for being controlled from a rich user interface;
means for determining a set of candidate content items by selecting ones of a plurality of available content items using the content selection criteria; and
means for propagating ones of the candidate content items of the set of candidate content items for presentation to the user, wherein presentation of the propagated ones of the candidate content items is adapted for being controlled from a simple user interface.

23. A computer readable medium storing software instructions which, when executed by a computer, cause the computer to perform a method for discovering, searching, selecting, and propagating content to a user, the method comprising:
receiving content selection criteria, wherein entry of the content selection criteria is adapted for being controlled from a rich user interface;
determining a set of candidate content items by selecting ones of a plurality of available content items using the content selection criteria; and
propagating ones of the candidate content items of the set of candidate content items for presentation to the user, wherein presentation of the propagated ones of the candidate content items is adapted for being controlled from a simple user interface.
